(19) United States
(12) Patent Application Publication
(10) Pub. No.: US 2014/0195586 A1
(43) Pub. Date: Jul. 10, 2014

(54) MESSAGE TRANSMITTING SYSTEM AND METHOD FOR DISTRIBUTED DATA INTEROPERABILITY

(71) Applicant: KOREA INSTITUTE OF SCIENCE & TECHNOLOGY INFORMATION, Daejeon (KR)

(72) Inventors: Youngyou Kook, Gyeonggi-do (KR); Hongro Lee, Daejeon (KR); Joon Lee, Daejeon (KR); Minwoo Park, Daejeon (KR); Kiseok Choi, Daejeon (KR); Jaesoo Kim, Daejeon (KR)

(73) Assignee: KOREA INSTITUTE OF SCIENCE & TECHNOLOGY INFORMATION, Daejeon (KR)

(21) Appl. No.: 14/129,329

(22) PCT Filed: Nov. 29, 2012
(86) PCT No.: PCT/KR2012/010243

§ 371 Date: Dec. 26, 2013

(30) Foreign Application Priority Data
Feb. 23, 2012 (KR) 10-2012-0018633

(51) Int. Cl. H04L 29/08

(52) U.S. Cl. CPC H04L 67/10
USPC 709/202

(57) ABSTRACT

Provided is a message transmitting system and method for distributed data interoperability. That is, the system and method may include a master device configured to register one or more operating devices, each operating a corresponding legacy system, as slave devices, so as to form each domain for processing an individual process, and to generate and transfer a process request message with respect to a slave device forming a corresponding domain according to processing of a predetermined process, and a slave device configured to be registered in one or more operating devices, each operating as a master device so as to form each domain, to execute a requested process as a process request message transferred from a corresponding master device according to domain-based process processing is received, to generate a process response message including a process execution result, and to transfer the generated process response message to the corresponding master device, thereby forming a plurality of domains for processing individual processes to enable a predetermined operating device to be shared among the domains, and enabling a process for multiple purposes in addition to a process for a single purpose.

### TECHNICAL FIELD

The present disclosure relates to a distributed data interoperability, and more particularly, to a message transmitting system and method for distributed data interoperability, which applies an interoperation structure among operating devices, each operating a corresponding legacy system, so as to form a plurality of domains for processing individual processes, and to enable a predetermined operating device to be shared among the domains, and defines a message transmitting method among operating devices according to domain-based process processing.

### BACKGROUND ART

An agent, which is a software agent, is regarded as a type of computer program, and may be defined as ‘an autonomous process that executes a task on behalf of a user for a predetermined purpose, and a system having a function of cooperating with another agent or a user for executing a task’.

The software agent possesses various characteristics according to purposes. For example, there are agents including characteristics of autonomy for acting and making decisions without direct commands or interference from a user or another agent, intelligence for making a plan by recognizing a user's intention based on knowledge base and interfering ability, and for learning and understanding new knowledge by itself, mobility for moving a task requested by a user to a host where the task is actually processed and executed, as opposed to executing the task in a current host, so as to increase efficiency of the performance and to reduce network load, sociality which is based on exchanging messages between agents when a single agent is incapable of executing a task, and needs help from another agent to execute the task, reactivity for reacting according to a change in an environment, veracity for preventing an exchange of wrong information, and the like.

In addition, to execute a predetermined task using a distributed data that is operated autonomously and independently in a legacy system based on the described characteristics, the software agent typically employs a Multi-Agent Framework (MAF) that establishes a cooperative relationship which processes a task with help from a plurality of agents or application programs.

The multi-agent is an agent that establishes a cooperative relationship that processes a task with help from a plurality of agents or application programs for executing a predetermined task, and a multi-agent based structure where a plurality of agents are executed, a method of configuring a plurality of agents, and a message exchanging method among agents need to be provided.

### DETAILED DESCRIPTION OF THE INVENTION

### Technical Problem

Therefore, the present disclosure has been made in view of the above-mentioned problems, and an aspect of the present disclosure is to provide a message transmitting system and method for distributed data interoperability, in which a master device registers, as slave devices, one or more operating devices, each operating a corresponding legacy system, so as to form each domain for processing an individual process, and generates and transfers a process request message with respect to a slave device forming a corresponding domain according to processing of a predetermined process, and the slave device executes the predetermined process as the process request message is received, generates a process response message including a process execution result, and transfers the generated process response message to a corresponding master device, thereby forming domains to enable a predetermined operating device to be shared among domains for processing individual processes, and defining a message transmitting scheme among the operating devices according to domain-based process processing.

Another aspect of the present disclosure is to provide an operating device and method that registers, as slave devices, one or more operating devices, each operating a corresponding legacy system, so as to form each domain for processing an individual process, determines each slave device forming a corresponding domain according to processing of a predetermined process, transfers a process request message generated with respect to the determined slave device, and receives a process response message including a process execution result associated with the predetermined process, thereby forming domains to enable a predetermined operating device to be shared among domains for processing individual processes, and defining a message transmitting scheme among the operating devices according to domain-based process processing.

Another aspect of the present disclosure is to provide an operating device and method that is registered, as a slave device, in one or more operating devices, each operating as a master device, so as to form each domain for processing an individual process, executes a requested process as a process request message transferred from a corresponding master device according to domain-based process processing is received, generates a process response message including a process execution result associated with the process, and transfers the process response message to the corresponding master device, thereby forming domains to enable a predetermined operating device to be shared among domains for processing individual processes, and defining a message transmitting scheme among the operating devices according to domain-based process processing.

### Technical Solution

In accordance with an aspect of the present disclosure, there is provided a message transmitting system for distributed data interoperability, the message transmitting system including: a master device configured to register one or more operating devices, each operating a corresponding legacy system, as slave devices, so as to form each domain for processing an individual process, and to generate and transfer a process request message with respect to a slave device forming a corresponding domain according to processing of a predetermined process; and a slave device configured to be registered in one or more operating devices, each operating as a master device so as to form each domain, to execute a requested process as a process request message transferred from a corresponding master device according to domain-based process processing is received, to generate a process response message including a process execution result, and to transfer the generated process response message to the corresponding master device.

The slave device is configured to perform: generating two or more process response messages and setting priorities according to the process request message received from a corresponding master device for each domain; and compressing with respect to the process response messages for which the priorities are set, and selecting and transmitting a corresponding process response message based on the set priority.

The slave device is configured to set the priority for each of the two or more process response messages based on a predetermined criterion, and to assign a different bandwidth of a transmission channel based on the set priority.

The master device is configured to additionally register, as a slave device, at least one operating device that is registered in advance in a predetermined domain as a slave device, so as to form a separate domain.

The master device is configured to be registered, as a slave device, in one or more operating devices, each operating as a master device, so as to form each domain.

In accordance with another aspect of the present disclosure, there is provided an operating device, including: an operation management unit configured to register, as slave devices, one or more operating devices, each operating a corresponding legacy system, so as to form each domain for processing an individual process; and a work management unit configured to determine each slave device forming a corresponding domain according to processing of predetermined process, to transfer a process request message generated with respect to the determined slave device, and to receive a process response message including a process execution result associated with the predetermined process.

The operation management unit is configured to additionally register, as a slave device, at least one operating device that is registered in advance in a predetermined domain as a slave device, so as to form a separate domain.

The operation management unit is configured to be registered, as a slave device, in one or more operating devices, each operating as a master device that forms a corresponding domain, so as to form each domain.

The work management unit is configured to perform: generating two or more process response messages and setting priorities according to the process request message received from a corresponding master device for each domain, and compressing with respect to the process response messages for which the priorities are set, and selecting and transmitting a corresponding process response message based on the set priority.

The work management unit is configured to perform: setting the priority with respect to each of the two or more process response messages based on a predetermined criterion, and assigning a different bandwidth of a transmission channel based on the set priority.

In accordance with another aspect of the present disclosure, there is provided an operating device, including: an operation management unit configured to be registered, as a slave device, in one or more operating devices, each operating as a master device, so as to form each domain for processing an individual process; and a work management unit configured to execute a requested process as a process request message transferred from a corresponding master device according to a domain-based process processing is received, to generate a process response message including a process execution result associated with the process, and to transfer the generated process response message to the corresponding master device.

The work management unit is configured to perform: generating two or more process response messages and setting priorities according to the process request message received from a corresponding master device for each domain; and compressing with respect to the process response messages for which the priorities are set, and selecting and transmitting a corresponding process response message based on the set priority.

The work management unit is configured to set the priority for each of the two or more process response messages based on a predetermined criterion, and assign a different bandwidth of a transmission channel based on the set priority.

In accordance with another aspect of the present disclosure, there is provided a message transmitting method, the method including: a domain forming in which a master device registers, as slave devices, one or more operating devices, each operating a corresponding legacy system, so as to form each domain for processing an individual process; a request message transferring in which the master device generates and transfers a process request message with respect to a slave device forming a corresponding domain according to processing of a predetermined process; a process executing in which the slave device executes the predetermined process as the process request message is received; and a response message transferring in which the slave device generates a process response message including a process execution result associated with the process, and transfers the generated process response message to the corresponding master device.

The domain forming includes additionally registering, as a slave device, at least one operating device that is registered in advance in a predetermined domain as a slave device, so as to form a separate domain.

The response message transferring includes: a response message generating to generate two or more process response messages, based on the process request message received from a corresponding master device for each domain; a priority setting to set priorities with respect to the two or more generated process response messages; a compressing to execute compressing with respect to the process response messages for which the priorities are set; and a response message transmitting to select and transmit a process response message which is compressed, based on the set priority.

The priority setting includes setting the priority with respect to each of the two or more process response messages based on a predetermined criterion, and assigning a different bandwidth of a transmission channel based on the set priority.

In accordance with another aspect of the present disclosure, there is provided an operating method of an operating device, the method including: a domain forming to register, as slave devices, one or more operating devices, each operating a corresponding legacy system, so as to form each domain for processing an individual process; a device identifying to determine each slave device forming a corresponding domain according to processing of a predetermined process; a request message transferring to transfer a process request message generated with respect to the determined slave device; and a response message receiving to receive a process response message including a process execution result associated with the predetermined process.

The domain forming includes additionally registering, as a slave device, at least one operating device that is registered in advance in a predetermined operating device as a slave device, so as to form a separate domain.

The method further includes a slave operating in which the operating device is registered as a slave device in one or more operating devices, each operating as a master device that forms a corresponding domain, so as to form each domain, a response message generating to generate two or more process response messages based on the process request message received from a corresponding master device for each domain, a priority setting to set priorities with respect to the two or more generated process response messages, a compressing to execute compressing with respect to the process response messages for which the priorities are set, and a response message transmitting to select and to transmit a process response message that is compressed, based on the set priority.

In accordance with another aspect of the present disclosure, there is provided an operating method of an operating device, the method including: a domain forming in which the operating device is registered as a slave device in one or more operating devices, each operating as a master device, so as to form each domain for processing an individual process; a process executing to execute a requested process as a process request message transferred from a corresponding master device according to domain-based process processing is received; and a response message transferring to generate a process response message including a process execution result associated with the process, and to transfer the generated process response message to the corresponding master device.

The response message transferring includes a response message generating to generate two or more process response messages based on the process request message received from a corresponding master device for each domain, a priority setting to set priorities with respect to the two or more generated process response messages, a compressing to execute compressing with respect to the process response messages for which the priorities are set, and a response message transmitting to select and transmit a process response message that is compressed, based on the set priority.

The priority setting includes setting the priority with respect to each of the two or more process response messages based on a predetermined criterion, and assigning a different bandwidth of a transmission channel based on the set priority.

In accordance with another aspect of the present disclosure, there is provided a computer-readable recording medium including an instruction for executing: a domain forming to register one or more operating devices, each operating a corresponding legacy system, as slave devices, so as to form each domain for processing an individual process; a device identifying to determine each slave device forming a corresponding domain according to processing of a predetermined process; a request message transferring to transfer a process request message generated with respect to the determined slave device; and a response message receiving to receive a process response message including a process execution result associated with the predetermined process.

The domain forming includes additionally registering, as a slave device, at least one operating device that is registered in advance in a predetermined domain as a slave device, so as to form a separate domain.

The computer-readable recoding medium further includes an instruction for executing a slave operating in which an operating device is registered as a slave device in one or more operating devices, each operating as a master device that forms a corresponding domain, so as to form each domain, a response message generating to generate two or more process response messages based on the process request message received from a corresponding master device for each domain, a priority setting to set priorities with respect to the two or more generated process response messages, a compressing to execute compressing with respect to the process response messages for which the priorities are set, and a response message transmitting to select and transmit a process response message that is compressed, based on the set priority.

In accordance with another aspect of the present disclosure, there is provided a computer-readable recording medium including an instruction for executing: a domain forming in which an operating device is registered as a slave device in one or more operating devices, each operating as a master device, so as to form each domain for processing an individual domain; a process executing to execute a requested process as a process request message transferred from a corresponding master device according to domain-based process processing is received; and a response message transferring to generate a process response message including a process execution result associated with the process, and to transfer the generated process response message to the corresponding master device.

The response message transferring includes a response message generating to generate two or more process response messages based on the process request message received from a corresponding master device for each domain, a priority setting to set priorities with respect to the two or more generated process response messages, a compressing to execute compressing with respect to the process response messages for which the priorities are set, and a response message transmitting to select and transmit a process response message that is compressed, based on the set priority.

The priority setting includes setting the priority with respect to each of the two or more process response messages based on a predetermined criterion, and assigning a different bandwidth of a transmission channel based on the set priority.

### Advantageous Effects

Therefore, a message transmitting system and method for distributed data interoperability according to the present disclosure applies interoperation among operating devices, each operating a corresponding legacy system, so as to form a plurality of domains for processing individual processes, and to enable a predetermined operating device to be shared among domains and thus, a process for multiple purposes is possible in addition to a process for a single purpose.

Also, a message transmitting scheme among operating devices in association with domain-based process processing is defined and thus, efficiency and reliability of transmission of a message according to distributed data interoperability are improved.

### BRIEF DESCRIPTION OF THE DRAWINGS

FIG. 1 is a schematic diagram of a message transmitting system for distributed data interoperability according to an embodiment of the present disclosure;

FIG. 2 is a schematic diagram of a master device according to an embodiment of the present disclosure;

FIG. 3 is a schematic diagram of a slave device according to an embodiment of the present disclosure;

FIG. 4 is a diagram illustrating a configuration of a message according to an embodiment of the present disclosure;

FIG. 5 is a schematic flowchart illustrating an operating method of a message transmitting system for distributed data interoperability according to an embodiment of the present disclosure;

FIG. 6 is a schematic flowchart illustrating an operating method of a first operating device according to an embodiment of the present disclosure; and

FIG. 7 is a schematic flowchart illustrating an operating method of a second operating device according to an embodiment of the present disclosure.

### MODE FOR CARRYING OUT THE INVENTION

Some embodiments of the present disclosure are now described with reference to the drawings.

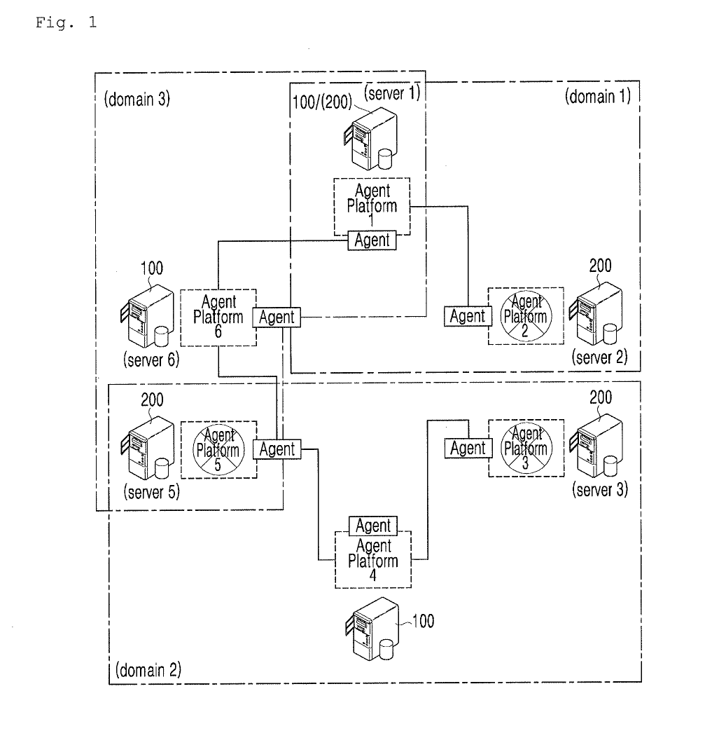

FIG. 1 is a schematic diagram of a message transmitting system for distributed data interoperability according to an embodiment of the present invention.

As illustrated in FIG. 1, the system includes a first operating device 100 configured to register, as slave devices, one or more operating device, each operating a corresponding legacy system, so as to form each domain for processing an individual process, and to generate and transfer a process request message for domain-based process processing; and a second operating device 200 configured to be registered in at least one first operating device 100, each operating as a master device, so as to operate as a slave device that forms each domain, and to generate and transfer a process response message according to domain-based process processing.

Here, each of the first operating device 100 and the second operating device 200 refers to a server that operates a corresponding legacy system. Each contains an agent for processing a process requested by a user, and additionally contains an agent platform for interoperation among a plurality of agents, thereby simultaneously operating as a master device and a slave device for one another.

Hereinafter, descriptions will be provided by assuming the first operating device 100 (hereinafter referred to as a ‘master device’) in which a contained agent platform is activated as an operating device that operates as a master. In addition, it is assumed that the second operating device 200 (hereinafter referred to as a ‘slave device’) in which the contained agent platform is deactivated is an operating device that operates as a slave.

The master device 100 registers a plurality of slave devices 200, so as to form each domain for processing an individual process.

In particular, as a contained agent platform is activated, the master device 100 operates as a master device, and registers access addresses (Internet Protocol (IP)) of one or more slave devices 200, each operating a corresponding legacy system, so as to form a domain for processing a predetermined process. In this example, the master device 100 forms a plurality of domains for processing individual processes. That is, a master device 100 corresponding to ‘server 1’ registers an operating device corresponding to ‘server 2’ as the slave device 200, so as to form ‘domain 1’. Also, a master device 100 corresponding to ‘server 4’ registers operating devices corresponding to ‘server 3’ and ‘server 5’ as the slave devices 200, so as to form ‘domain 2’. In addition, a master device 100 corresponding to ‘server 6’ registers operating devices corresponding to ‘server 1’ and ‘server 5’ as the slave devices 200, so as to form ‘domain 3’. Here, in a case of ‘domain 3’, the operating device corresponding to ‘server 6’ operates as the master device 100 and thus, ‘server 1’ that operates as a master device in ‘domain 1’ operates as the slave device 200 in ‘domain 3’. The master device 100 registers, as a slave device, an operating device that forms another domain, so as to form a domain. That is, ‘server 1’ that operates as the master device 100 in ‘domain 1’ operates as the slave device 200 in ‘domain 3’. Also, ‘server 5’ that operates as the slave device 200 in ‘domain 2’ operates as the slave device 200 in ‘domain 3’.

Also, the master device 100 generates and transfers a process request message with respect to each slave device 200 that forms the domain according to processing of the predetermined process.

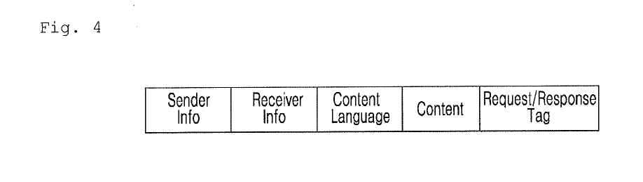

In particular, the master device 100 determines an access address of each slave device 200 of each domain according to domain-based process processing, generates a process request message based on the determined access address, and transfers the generated process request message to a corresponding slave device 200 so as to request the domain-based process processing. In this example, a configuration of a protocol of the process request message generated by the master device 100 may include, for example, information of message sender and receiver (Sender Info and Receiver Info), a message language (Contents Language), a message (Contents), and request/response tags (Request/Response Tag), as illustrated in FIG. 4. Here, for the process request message, a request tag may be selected from among the request/response tags.

The slave device 200 is registered in the master device 100, and forms each domain for processing an individual process.

In particular, the slave device 200 is registered in a plurality of master devices 100, and forms each domain for processing an individual process. That is, an operating device corresponding to ‘server 2’ is registered, as the slave device 200, in a master device 100 corresponding to ‘server 1’, so as to form ‘domain 1’. Operating devices corresponding to ‘server 3’ and ‘server 5’ are registered, as the slave devices 200, in a master device 100 corresponding to ‘server 4’, so as to form ‘domain 2’. In addition, operating devices corresponding to ‘server 1’ and ‘server 5’ are registered, as the slave devices 200, in a master device 100 corresponding to ‘server 6’, so as to form ‘domain 3’.

Also, as a process request message transferred from a corresponding master device 100 according to domain-based process processing is received, the slave device 200 executes a requested process.

In particular, the slave device 200 receives a process request message from a corresponding master device 100 according to domain-based process processing, and identifies a domain based on the process request message so as to execute a requested process for each domain. That is, according to process processing in ‘domain 1’, a slave device 200 corresponding to ‘server 2’ identifies a domain based on a process request message received from a master device 100 corresponding to ‘server 1’, and executes a corresponding process. Also, according to process processing in ‘domain 2’, slave devices 200 corresponding to ‘server 3’ and ‘server 5’ identify a domain based on a process request message received from a master device 100 corresponding to ‘server 4’, and execute a corresponding process. In addition, according to process processing in ‘domain 3’, slave devices 200 corresponding to ‘server 1’ and ‘server 5’ identify a domain based on a process request message received from a master device 100 corresponding to ‘server 6’, and execute a corresponding process. In this example, the process executed through the slave device 200 executes basic functions of Extract, Transform, and Load (ETL), and includes functions of transferring and refining. Particularly, a data refining function is executed based on a user-defined rule function that is generated by a manager according to data management policies.

In addition, the slave device 200 generates a process response message including a process execution result, and transfers the generated process response message to a corresponding master device 100.

In particular, the slave device 200 generates a process response message including a process execution result associated with a process executed in response to a process request message received from a corresponding master device 100 for each domain, that is, a result of processing through the basic functions of ETL and transferring and refining functions. In this example, a configuration of a protocol of the process request message generated by the master device 100 may include, for example, information of message sender and receiver (Sender Info and Receiver Info), a message language (Contents Language), a message (Contents), and request/response tags (Request/Response Tag), as illustrated in FIG. 4. Here, for the process response message, a response tag is selected from the request/response tags. Also, the slave device 200 sets a priority with respect to the generated process response message based on a user-defined scheme. In this example, the slave device 200 may apply the user-defined scheme, for example, a scheme of assigning a priority with respect to a message of which transmission with respect to a packet having a fixed length is preferentially required or a scheme of assigning a priority based on a size of a process response message. Through this, the slave device 200 sets priorities with respect to a plurality of process response messages generated according to domain-based process processing, and assigns a different bandwidth of a transmission channel based on the set priority. In addition, the slave device 200 executes compression with respect to the process response message of which the priority is set, so as to optimize an amount of transmitted data. In this example, the slave device 200 proceeds with lossless compression using, for example, basic API of Java. The compression of the message converts a message string into binary. For this, DEFLATE algorithm based Java API is utilized. For reference, decompression is performed in reverse order of the message compression. The message string is converted into binary using BASE64, and is restored to an original message using a decompression algorithm. In addition, the slave device 200 proceeds with encryption with respect to the compressed process response message, by taking into consideration data security. In this example, the slave device 200 executes encryption based on a basic SEED algorithm using an address of a Network Interface Card (NIC) contained in the master device 100 as a key value. For reference, the master device 100 that receives the encrypted process response message may proceed with decryption using the address of the NIC contained in the master device 100. In addition, the slave device 200 selects and transmits a compressed process response message, based on the set priority. In this example, the slave device 200 may determine a priority set for a compressed process response message by applying a Weighted Round Robin (WRR) scheme that assigns a high weight to a message having a high priority so as to enable the message to be preferentially selected in a transmission channel, and may transmit a process response message to a corresponding master device 100 for each domain, based on the determined priority.

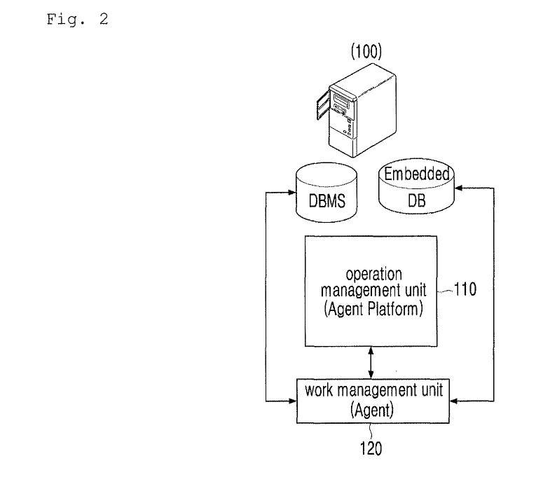

Hereinafter, a detailed configuration of the master device 100 according to an embodiment of the present disclosure will be described with reference to FIG. 2.

That is, as illustrated in FIG. 2, the master device 100 includes an operation management unit 110 configured to register, as slave devices, one or more operating devices, each operating a corresponding legacy system, so as to form each domain for processing an individual process; and a work management unit 120 configured to transfer a process request message generated with respect to each slave device 200 forming a corresponding domain according to processing of a predetermined process. Here, the operation management unit 110 is referred to as an agent platform for processing interoperation among agents installed in an operating device. Also, the work management unit 120 is referred to as an agent that is installed in an operating device for processing a process requested by a user, which interoperates with a Data Base Management System (DBMS) that is contained in a corresponding server for managing additional data and an embedded Data Base (DB) for managing access information of the DBMS.

The operation management unit 110 registers a plurality of slave devices 200 and forms each domain for processing an individual process.

In particular, as a contained agent platform is activated, the operation management unit 110 operates as a master device, and registers access addresses (IP) of one or more slave devices 200, each operating a corresponding legacy system, so as to form a domain for processing a predetermined process. In this example, the operation management unit 110 forms a plurality of domains for processing individual processes, and also registers, as the slave device 200, an operating device that forms another domain, so as to form a domain.

The work management unit 120 generates and transfers a process request message with respect to each slave device 200 forming the domain according to processing of the predetermined process.

In particular, the work management unit 120 determines an access address of each slave device 200 forming a domain according to domain-based process processing, generates a process request message based on the determined access address, and transfers the generated process request message to a corresponding slave device 200 so as to request domain-based process processing. In this example, a configuration of a protocol of the process request message generated by the work management unit 120 may include, for example, information of message sender and receiver (Sender Info and Receiver Info), a message language (Contents Language), a message (Contents), and request/response tags (Request/Response Tag), as illustrated in FIG. 4. Here, for the process request message, a request tag may be selected from among the request/response tags.

Also, the work management unit 120 receives a process response message from the slave device 200 in response to transferring of the process request message.

In particular, the work management unit 120 receives a process response message from each slave device 200 forming a corresponding domain according to domain-based process request message transferring. In this example, the process response message received from the slave device 200 may include a process execution result associated with a process executed in response to the process request message, that is, a result of processing through basic functions of ETL and transferring and refining functions.

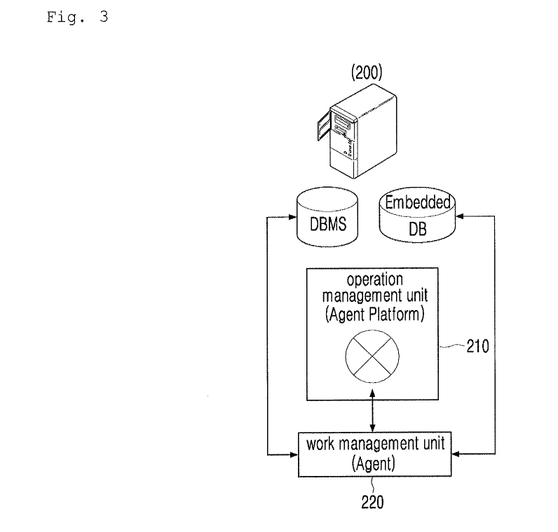

Hereinafter, a detailed configuration of the slave device 200 will be described with reference to FIG. 3.

That is, as illustrated in FIG. 3, the slave device 200 includes an operation management unit 210 configured to be registered in a plurality of master devices 100 and to form each domain for processing an individual process; and a work management unit 220 configured to execute a requested process as a process request message transferred from a corresponding master device according to domain-based process processing is received. Here, the operation management unit 210 is referred to as an agent platform that is installed in an operating device for processing interoperation among agents. When it is maintained in a deactivated state after forming a domain, a corresponding operating device is driven as the slave device 200. Also, the work management unit 220 is referred to as an agent that is installed in an operating device for processing a process requested by a user, and the work management unit 220 includes a DBMS that is contained in a corresponding server for managing additional data, and an embedded DB for managing access information of the DBMS.

The operation management unit 210 is registered in the master device 100 and forms a domain.

In particular, the operation management unit 210 is registered in a plurality of master devices 100, and forms each domain for processing an individual process.

The work management unit 220 executes a requested process as a process request message transferred from a corresponding master device 100 according to domain-based process processing is received.

In particular, the work management unit 220 receives a process request message from a corresponding master device 100 according to the domain-based process processing, identifies a domain based on the process request message, and executes a requested process for each domain. In this example, as the process request message is received, the work management unit 220 executes basic functions of ETL, and additionally executes transferring and refining functions. In particular, a data refining function is performed based on a user-defined rule function that is generated by a manager according to data management policies.

Also, the work management unit 220 generates a process response message including a process execution result associated with a process executed in response to a process request message received from a corresponding master device 100 for each domain.

In particular, the work management unit 220 generates a process response message including a process execution result associated with a process executed in response to a process request message received from a corresponding master device 100 for each domain, that is, a result of processing through the basic functions of ETL and transferring and refining functions. In this example, a configuration of a protocol of the process request message generated by the work management unit 220 may include, for example, information of message sender and receiver (Sender Info and Receiver Info), a message language (Contents Language), a message (Contents), and request/response tags (Request/Response Tag), as illustrated in FIG. 4. Here, for the process response message, a response tag may be selected from among the request/response tags.

In addition, the work management unit 220 sets a priority with respect to the process response message generated based on a user-defined scheme.

In particular, the work management unit 220 may apply the user-defined scheme, for example, a scheme of assigning a priority with respect to a message of which transmission with respect to a packet having a fixed length is preferentially required or a scheme of assigning a priority based on a size of a process response message. Through this, the work management unit 220 sets priorities with respect to a plurality of process response messages generated according to domain-based process processing, and assigns a different bandwidth of a transmission channel based on the set priority.

Also, the work management unit 220 executes compression with respect to the process response message of which the priority is set, so as to optimize an amount of transmitted data.

In particular, the work management unit 220 proceeds with lossless compression using, for example, basic API of Java. The compression of the message converts a message string into binary. For this, DEFLATE algorithm based Java API is utilized. For reference, decompression is performed in reverse order of the message compression. The message string is converted into binary using BASE64, and is restored to an original message using a decompression algorithm.

In addition, the work management unit 220 proceeds with encryption with respect to the compressed process response message, by taking into consideration data security.

In particular, the work management unit 220 executes encryption based on a basic SEED algorithm using an address of Network interface Card (NIC) contained in the master device 100 as a key value. For reference, the master device 100 that receives the encrypted process response message may proceed with decryption using the address of the NIC contained in the master device 100.

In addition, the work management unit 220 selects and transmits a process response message that is compressed, based on the set priority.

In particular, the work management unit 220 may determine a priority set for a compressed process response message by applying a WRR scheme that assigns a high weight to a message having a high priority to enable the message to be preferentially selected in a transmission channel, and may transmit a process response message to a corresponding master device 100 for each domain, based on the determined priority.

As described above, the message transmitting system for distributed data interoperability according to the present disclosure applies interoperation among operating devices, each operating a corresponding legacy system, so as to form a plurality of domains for processing individual processes, and to enable a predetermined operating device to be shared among domains and thus, a process for multiple purposes is possible in addition to a process for a single purpose. Also, a message transmitting scheme among operating devices in association with domain-based process processing is defined and thus, efficiency and reliability of transmission of a message according to distributed data interoperability are improved.

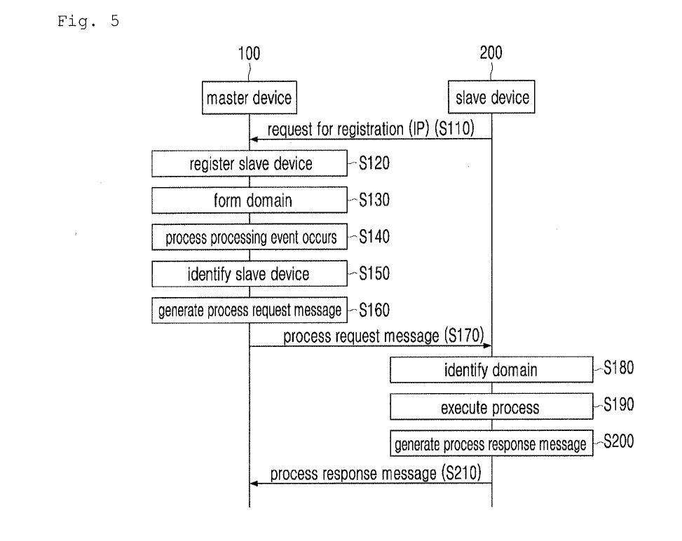

Hereinafter, a message transmitting method for distributed data interoperability according to an embodiment of the present disclosure will be described with reference to FIGS. 5 through 7. Here, for ease of description, the configurations illustrated in FIGS. 1 through 4 will be described using corresponding reference numerals.

First, an operating method of a message transmitting system for distributed data interoperability according to an embodiment of the present disclosure will be described with reference to FIG. 5.

First, the master device 100 registers a plurality of slave devices 200 and forms each domain for processing an individual process in steps S110 through S130.

Preferably, as a contained agent platform is activated, the master device 100 operates as a master device and registers access addresses (IP) of one or more slave devices 200, each operating a corresponding legacy system, and forms a domain for processing a predetermined process. In this example, the master device 100 forms a plurality of domains for processing individual processes. That is, a master device 100 corresponding to ‘server 1’ registers an operating device corresponding to ‘server 2’ as the slave device 200, so as to form ‘domain 1’. Also, a master device 100 corresponding to ‘server 4’ registers operating devices corresponding to ‘server 3’ and ‘server 5’ as the slave devices 200, so as to form ‘domain 2’. In addition, a master device 100 corresponding to ‘server 6’ registers operating devices corresponding to ‘server 1’ and ‘server 5’ as the slave devices 200, so as to form ‘domain 3’. Here, in a case of ‘domain 3’, the operating device corresponding to ‘server 6’ operates as the master device 100 and thus, ‘server 1’ that operates as a master device in ‘domain 1’ operates as the slave device 200 in ‘domain 3’. The master device 100 registers, as a slave device, an operating device that forms another domain, so as to form a domain. That is, ‘server 1’ that operates as the master device 100 in ‘domain 1’ operates as the slave device 200 in ‘domain 3’. Also, ‘server 5’ that operates as the slave device 200 in ‘domain 2’ operates as the slave device 200 in ‘domain 3’.

Also, the master device 100 generates and transfers a process request message with respect to each slave device 200 that forms the domain according to processing of the predetermined process in steps S140 through S170.

Preferably, the master device 100 determines an access address of each slave device 200 of each domain according to domain-based process processing, generates a process request message based on the determined access address, and transfers the generated process request message to a corresponding slave device 200 so as to request the domain-based process processing. In this example, a configuration of a protocol of the process request message generated by the master device 100 may include, for example, information of message sender and receiver (Sender Info and Receiver Info), a message language (Contents Language), a message (Contents), and request/response tags (Request/Response Tag), as illustrated in FIG. 4. Here, for the process request message, a request tag may be selected from among the request/response tags.

Subsequently, as a process request message transferred from a corresponding master device 100 according to domain-based process processing is received, the slave device 200 executes a requested process in steps S180 through S190.

The slave device 200 receives a process request message from a corresponding master device 100 according to domain-based process processing, and identifies a domain based on the process request message so as to execute a requested process for each domain. That is, according to process processing in ‘domain 1’, a slave device 200 corresponding to ‘server 2’ identifies a domain based on a process request message received from a master device 100 corresponding to ‘server 1’, and executes a corresponding process. Also, according to process processing in ‘domain 2’, slave devices 200 corresponding to ‘server 3’ and ‘server 5’ identify a domain based on a process request message received from a master device 100 corresponding to ‘server 4’, and executes a corresponding process. In addition, according to process processing in ‘domain 3’, slave devices 200 corresponding to ‘server l’ and ‘server 5’ identify a domain based on a process request message received from a master device 100 corresponding to ‘server 6’, and execute a corresponding process. In this example, the process executed through the slave device 200 executes basic functions of ETL, and includes functions of transferring and refining. Particularly, a data refining function is executed based on a user-defined rule function that is generated by a manager according to data management policies.

Subsequently, the slave device 200 generates a process response message including a process execution result, and transfers the generated process response message to a corresponding master device 100 in steps S200 through S210.

The slave device 200 generates a process response message including a process execution result associated with a process executed in response to a process request message received from a corresponding master device 100 for each domain, that is, a result of processing through basic functions of ETL and transferring and refining functions. In this example, a configuration of a protocol of the process request message generated by the master device 100 may include, for example, information of message sender and receiver (Sender Info and Receiver Info), a message language (Contents Language), a message (Contents), and request/response tags (Request/Response Tag), as illustrated in FIG. 4. Here, for the process response message, a response tag may be selected from the request/response tags. Also, the slave device 200 sets a priority with respect to the generated process response message based on a user-defined scheme. In this example, the slave device 200 may apply the user-defined scheme, for example, a scheme of assigning a priority with respect to a message of which transmission with respect to a packet having a fixed length is preferentially required or a scheme of assigning a priority based on a size of a process response message. Through this, the slave device 200 sets priorities with respect to a plurality of process response messages generated according to domain-based process processing, and assigns a different bandwidth of a transmission channel based on the set priority. In addition, the slave device 200 executes compression with respect to the process response message of which the priority is set, so as to optimize an amount of transmitted data. In this example, the slave device 200 proceeds with lossless compression using, for example, basic API of Java. The compression of the message converts a message string into binary. For this, DEFLATE algorithm based Java API is utilized. For reference, decompression is performed in reverse order of the message compression. The message string is converted into binary using BASE64, and is restored to an original message using a decompression algorithm. In addition, the slave device 200 proceeds with encryption with respect to the compressed process response message, by taking into consideration data security. In this example, the slave device 200 executes encryption based on a basic SEED algorithm using an address of an NIC contained in the master device 100 as a key value. For reference, the master device 100 that receives the encrypted process response message may proceed with decryption using the address of the NIC contained in the master device 100. In addition, the slave device 200 selects and transmits a compressed process response message, based on the set priority. In this example, the slave device 200 may determine a priority set for a compressed process response message by applying a WRR scheme that assigns a high weight to a message having a high priority to enable the message to be preferentially selected in a transmission channel, and may transmit a process response message to a corresponding master device 100 for each domain, based on the determined priority.

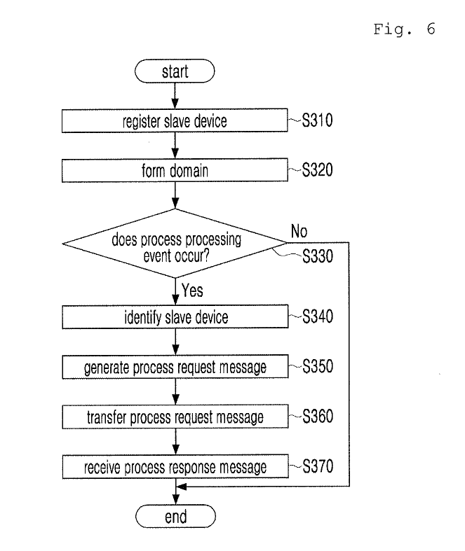

Hereinafter, an operating method of the master device 100 according to an embodiment of the present disclosure will be described with reference to FIG. 6.

First, the master device 100 registers a plurality of slave devices 200 and forms each domain for processing an individual process in steps S310 through S320.

As a contained agent platform is activated, the operation management unit 110 operates as a master device, and registers access addresses (Internet Protocol (IP)) of one or more slave devices 200, each operating a corresponding legacy system, so as to form a domain for processing a predetermined process. In this example, the operation management unit 110 forms a plurality of domains for processing individual processes, and also registers, as the slave device 200, an operating device that forms another domain, so as to form a domain.

Subsequently, the master device 100 generates and transfers a process request message with respect to each slave device 200 forming the domain according to the predetermined process processing in step S330 through S360.

The work management unit 120 determines an access address of each slave device 200 of each domain according to domain-based process processing, generates a process request message based on the determined access address, and transfers the generated process request message to a corresponding slave device 200 so as to request domain-based process processing. In this example, a configuration of a protocol of the process request message generated by the work management unit 120 may include, for example, information of message sender and receiver (Sender Info and Receiver Info), a message language (Contents Language), a message (Contents), and request/response tags (Request/Response Tag), as illustrated in FIG. 4. Here, for the process request message, a request tag may be selected from among the request/response tags.

Subsequently, the master device 100 receives a process response message from the slave device 200 in response to transferring of the process request message in step S370.

The work management unit 120 receives a process response message from each slave device 200 forming a corresponding domain according to domain-based process request message transferring. In this example, the process response message received from the slave device 200 may include a process execution result associated with a process executed in response to the process request message, that is, a result of processing through basic functions of ETL and transferring and refining functions.

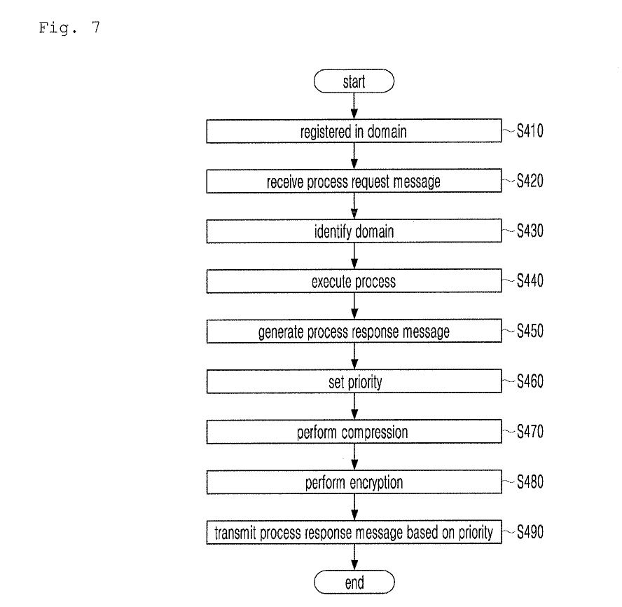

Hereinafter, an operating method of the slave device 200 will be described with reference to FIG. 7.

First, the slave device 200 is registered in the master device 100 and forms a domain in step S410.

The operation management unit 210 is registered in a plurality of master devices 100, and forms each domain for processing an individual process.

Subsequently, the slave device 200 executes a requested process as a process request message transferred from a corresponding master device 100 according to domain-based process processing is received in step S420 through S440.

In particular, the work management unit 220 receives a process request message from a corresponding master device 100 according to the domain-based process processing, identifies a domain based on the process request message, and executes a requested process for each domain. In this example, as the process request message is received, the work management unit 220 executes basic functions of ETL, and additionally executes transferring and refining functions. In particular, a data refining function is performed based on a user-defined rule function that is generated by a manager according to data management policies.

Subsequently, the slave device 200 generates a process response message including a process execution result associated with a process executed according to a process request message received from a corresponding master device 100 for each domain in step S450.

The work management unit 220 generates a process response message including a process execution result associated with a process executed in response to a process request message received from a corresponding master device 100 for each domain, that is, a result of processing through the basic functions of ETL and transferring and refining functions. In this example, a configuration of a protocol of the process request message generated by the work management unit 220 may include, for example, information of message sender and receiver (Sender Info and Receiver Info), a message language (Contents Language), a message (Contents), and request/response tags (Request/Response Tag), as illustrated in FIG. 4. Here, for the process response message, a response tag may be selected from among the request/response tags.

Subsequently, the slave device 200 sets a priority with respect to the generated process response message based on a user-defined scheme in step S460.

In particular, the work management unit 220 may apply the user-defined scheme, for example, a scheme of assigning a priority with respect to a message of which transmission with respect to a packet having a fixed length is preferentially required or a scheme of assigning a priority based on a size of a process response message. Through this, the work management unit 220 sets priorities with respect to a plurality of process response messages generated according to domain-based process processing, and assigns a different bandwidth of a transmission channel based on the set priority.

Subsequently, the slave device 200 executes compression with respect to the process response message of which the priority is set, so as to optimize an amount of transmitted data in step S470.

In particular, the work management unit 220 proceeds with lossless compression using, for example, basic API of Java. The compression of the message converts a message string into binary. For this, DEFLATE algorithm based Java API is utilized. For reference, decompression is performed in reverse order of the message compression. The message string is converted into binary using BASE64, and is restored to an original message using a decompression algorithm.

In addition, the slave device 200 proceeds with encryption with respect to the compressed process response message, by taking into consideration data security in step S480.

The work management unit 220 executes encryption based on a basic SEED algorithm using an address of an NIC contained in the master device 100 as a key value. For reference, the master device 100 that receives the encrypted process response message may proceed with decryption using the address of the NIC contained in the master device 100.

Subsequently, the slave device 200 selects and transmits a compressed process response message, based on the set priority in step S490.

The work management unit 220 may determine a priority set for a compressed process response message by applying a WRR scheme that assigns a high weight to a message having a high priority to enable the message to be preferentially selected in a transmission channel, and may transmit a process response message to a corresponding master device 100 for each domain, based on the determined priority.

As described above, the message transmitting system for distributed data interoperability according to the present disclosure applies interoperation among operating devices, each operating a corresponding legacy system, so as to form a plurality of domains for processing individual processes, and to enable a predetermined operating device to be shared among domains and thus, a process for multiple purposes is possible in addition to a process for a single purpose. Also, a message transmitting scheme among operating devices in association with domain-based process processing is defined and thus, efficiency and reliability of transmission of a message according to distributed data interoperability are improved.

The method or the steps of the algorithm that have been described with reference to the embodiments of the present disclosure may be embodied in a form of a program instruction that may be executed through various computer means, and may be recorded in a computer readable medium.

### INDUSTRIAL APPLICABILITY

A message transmitting system and method for distributed data interoperability according to the present disclosure passes a limit of an existing technology in that the system and method forms domains so as to enable a predetermined operating device to be shared among domains that process individual processes, and defines a message transmitting scheme among operating devices according to domain-based process processing. Accordingly, the present disclosure has an industrial applicability since it has a sufficiently high probability of being available on the market and can be substantially embodied.

1. A message transmitting system for distributed data interoperability, the message transmitting system comprising:
a master device configured to register one or more operating devices, each operating a corresponding legacy system, as slave devices, so as to form each domain for processing an individual process, and to generate and transfer a process request message with respect to a slave device forming a corresponding domain according to processing of a predetermined process; and
a slave device configured to be registered in one or more operating devices, each operating as a master device so as to form each domain, to execute a requested process as a process request message transferred from a corresponding master device according to domain-based process processing is received, to generate a process response message including a process execution result, and to transfer the generated process response message to the corresponding master device.

2. The message transmitting system as claimed in claim 1, wherein the slave device is configured to perform:
generating two or more process response messages and setting priorities according to the process request message received from a corresponding master device for each domain; and
compressing with respect to the process response messages for which the priorities are set, and selecting and transmitting a corresponding process response message based on the set priority.

3. The message transmitting system as claimed in claim 2, wherein the slave device is configured to set the priority for each of the two or more process response messages based on a predetermined criterion, and to assign a different bandwidth of a transmission channel based on the set priority.

4. The message transmitting system as claimed in claim 1, wherein the master device is configured to additionally register, as a slave device, at least one operating device that is registered in advance in a predetermined domain as a slave device, so as to form a separate domain.

5. The message transmitting system as claimed in claim 1, wherein the master device is configured to be registered, as a slave device, in one or more operating devices, each operating as a master device, so as to form each domain.

6. An operating device, comprising:
an operation management unit configured to register, as slave devices, one or more operating devices, each operating a corresponding legacy system, so as to form each domain for processing an individual process; and
a work management unit configured to determine each slave device forming a corresponding domain according to processing of a predetermined process, to transfer a process request message generated with respect to the determined slave device, and to receive a process response message including a process execution result associated with the predetermined process.

7. The operating device as claimed in claim 6, wherein the operation management unit is configured to additionally register, as a slave device, at least one operating device that is registered in advance in a predetermined domain as a slave device, so as to form a separate domain.

8. The operating device as claimed in claim 6, wherein the operation management unit is configured to be registered, as a slave device, in one or more operating devices, each operating as a master device that forms a corresponding domain, so as to form each domain.

9. The operating device as claimed in claim 8, wherein the work management unit is configured to perform:
generating two or more process response messages and setting priorities according to the process request message received from a corresponding master device for each domain; and
compressing with respect to the process response messages for which the priorities are set, and selecting and transmitting a corresponding process response message based on the set priority.

10. The operating device as claimed in claim 9, wherein the work management unit is configured to perform:
setting the priority with respect to each of the two or more process response messages based on a predetermined criterion, and assigning a different bandwidth of a transmission channel based on the set priority.

11. An operating device, comprising:
an operation management unit configured to be registered, as a slave device, in one or more operating devices, each operating as a master device, so as to form each domain for processing an individual process; and
a work management unit configured to execute a requested process as a process request message transferred from a corresponding master device according to a domain-based process processing is received, to generate a process response message including a process execution result associated with the process, and to transfer the generated process response message to the corresponding master device.

12. The operating device as claimed in claim 11, wherein the work management unit is configured to perform:
generating two or more process response messages and setting priorities according to the process request message received from a corresponding master device for each domain; and
compressing with respect to the process response messages for which the priorities are set, and selecting and transmitting a corresponding process response message based on the set priority.

13. The operating device as claimed in claim 12, wherein the work management unit is configured to set the priority for each of the two or more process response messages based on a predetermined criterion, and assign a different bandwidth of a transmission channel based on the set priority.

14. A message transmitting method, the method comprising:
a domain forming in which a master device registers, as slave devices, one or more operating devices, each operating a corresponding legacy system, so as to form each domain for processing an individual process;
a request message transferring in which the master device generates and transfers a process request message with respect to a slave device forming a corresponding domain according to processing of a predetermined process;
a process executing in which the slave device executes the predetermined process as the process request message is received; and
a response message transferring in which the slave device generates a process response message including a process execution result associated with the process, and transfers the generated process response message to the corresponding master device.

15. The message transmitting method as claimed in claim 14, wherein the domain forming comprises:
additionally registering, as a slave device, at least one operating device that is registered in advance in a predetermined domain as a slave device, so as to form a separate domain.

16. The message transmitting method as claimed in claim 14, wherein the response message transferring comprises:
a response message generating to generate two or more process response messages, based on the process request message received from a corresponding master device for each domain;
a priority setting to set priorities with respect to the two or more generated process response messages;
a compressing to execute compressing with respect to the process response messages for which the priorities are set; and
a response message transmitting to select and transmit a process response message which is compressed, based on the set priority.

17. The message transmitting method as claimed in claim 16, wherein the priority setting comprises:
setting the priority with respect to each of the two or more process response messages based on a predetermined criterion, and assigning a different bandwidth of a transmission channel based on the set priority.

18. An operating method of an operating device, the method comprising:
a domain forming to register, as slave devices, one or more operating devices, each operating a corresponding legacy system, so as to form each domain for processing an individual process;
a device identifying to determine each slave device forming a corresponding domain according to processing of a predetermined process;
a request message transferring to transfer a process request message generated with respect to the determined slave device; and
a response message receiving to receive a process response message including a process execution result associated with the predetermined process.

19. The method as claimed in claim 18, wherein the domain forming comprises:
additionally registering, as a slave device, at least one operating device that is registered in advance in a predetermined operating device as a slave device, so as to form a separate domain.

20. The method as claimed in claim 18, further comprising:
a slave operating in which the operating device is registered as a slave device in one or more operating devices, each operating as a master device that forms a corresponding domain, so as to form each domain;
a response message generating to generate two or more process response messages based on the process request message received from a corresponding master device for each domain;
a priority setting to set priorities with respect to the two or more generated process response messages;
a compressing to execute compressing with respect to the process response messages for which the priorities are set; and
a response message transmitting to select and to transmit a process response message that is compressed, based on the set priority.

21. An operating method of an operating device, the method comprising:
a domain forming in which the operating device is registered as a slave device in one or more operating devices, each operating as a master device, so as to form each domain for processing an individual process;
a process executing to execute a requested process as a process request message transferred from a corresponding master device according to domain-based process processing is received; and
a response message transferring to generate a process response message including a process execution result associated with the process, and to transfer the generated process response message to the corresponding master device.

22. The method as claimed in claim 21, wherein the response message transferring comprises:
a response message generating to generate two or more process response messages based on the process request message received from a corresponding master device for each domain;
a priority setting to set priorities with respect to the two or more generated process response messages;
a compressing to execute compressing with respect to the process response messages for which the priorities are set; and
a response message transmitting to select and transmit a process response message that is compressed, based on the set priority.

23. The method as claimed in claim 22, wherein the priority setting comprises:
setting the priority with respect to each of the two or more process response messages based on a predetermined criterion, and assigning a different bandwidth of a transmission channel based on the set priority.

24. A computer-readable recording medium including an instruction for executing:
a domain forming to register one or more operating devices, each operating a corresponding legacy system, as slave devices, so as to form each domain for processing an individual process;
a device identifying to determine each slave device forming a corresponding domain according to processing of a predetermined process;
a request message transferring to transfer a process request message generated with respect to the determined slave device; and
a response message receiving to receive a process response message including a process execution result associated with the predetermined process.

25. The computer-readable recording medium as claimed in claim 24, wherein the domain forming comprises:
additionally registering, as a slave device, at least one operating device that is registered in advance in a predetermined domain as a slave device, so as to form a separate domain.

26. The computer-readable recording medium as claimed in claim 24, wherein the computer-readable recoding medium further includes an instruction for executing:
a slave operating in which an operating device is registered as a slave device in one or more operating devices, each operating as a master device that forms a corresponding domain, so as to form each domain;
a response message generating to generate two or more process response messages based on the process request message received from a corresponding master device for each domain;
a priority setting to set priorities with respect to the two or more generated process response messages;
a compressing to execute compressing with respect to the process response messages for which the priorities are set; and
a response message transmitting to select and transmit a process response message that is compressed, based on the set priority.

27. A computer-readable recording medium including an instruction for executing:
a domain forming in which an operating device is registered as a slave device in one or more operating devices, each operating as a master device, so as to form each domain for processing an individual domain;
a process executing to execute a requested process as a process request message transferred from a corresponding master device according to domain-based process processing is received; and
a response message transferring to generate a process response message including a process execution result associated with the process, and to transfer the generated process response message to the corresponding master device.

28. The computer-readable recording medium as claimed in claim 27, wherein the response message transferring comprises:
a response message generating to generate two or more process response messages based on the process request message received from a corresponding master device for each domain;
a priority setting to set priorities with respect to the two or more generated process response messages;
a compressing to execute compressing with respect to the process response messages for which the priorities are set; and
a response message transmitting to select and transmit a process response message that is compressed, based on the set priority.

29. The computer-readable recording medium as claimed in claim 28, wherein the priority setting comprises:
setting the priority with respect to each of the two or more process response messages based on a predetermined criterion, and assigning a different bandwidth of a transmission channel based on the set priority.
